(19) United States
(12) Patent Application Publication
(10) Pub. No.: US 2011/0252311 A1
(43) Pub. Date: Oct. 13, 2011

(54) COMPUTER IMPLEMENTED SYSTEM AND METHOD FOR STORING A USER'S LOCATION IN A VIRTUAL ENVIRONMENT

(76) Inventors: Christopher E. KAY, Palo Alto, CA (US); Sam Lising, San Francisco, CA (US); Sepnendu Mohanty, Singapore (SG)

(21) Appl. No.: 13/082,640

(22) Filed: Apr. 8, 2011

Related U.S. Application Data
(60) Provisional application No. 61/322,370, filed on Apr. 9, 2010.

(51) Int. Cl. G06F 17/20

(52) U.S. Cl. 715/255

(57) ABSTRACT

A computer-implemented method for accessing an electronic document is provided comprising providing, by a server, an electronic document to a user of a first touchpoint device; receiving, by the first touchpoint device, an input from the user requesting a bookmark; creating a bookmark and a bookmark identifier; storing information about the electronic document in the bookmark; providing to the user, by the first touchpoint device, a bookmark identifier; entering, by the user, the bookmark identifier into a second touchpoint device; and displaying the electronic document on the second touchpoint device, wherein the electronic document displayed on the second touchpoint device has all information previously entered into the electronic document by the user using the first touchpoint device.

### CROSS-REFERENCE TO RELATED APPLICATIONS

This application claims priority to U.S. Provisional Patent Application Ser. No. 61/322,370, filed Apr. 9, 2010, entitled “Computer Implemented System and Method for Storing a User's Location in a Virtual Environment,” which is hereby incorporated by reference in its entirety.

### COPYRIGHT NOTICE

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### FIELD OF THE INVENTION

The invention relates generally to financial data systems. More particularly, the invention relates to methods and systems for providing user access to financial services across multiple platforms.

### BACKGROUND

To access the vast majority of financial services and products offered by a financial institution, a user must disclose personal information by completing a document such as a questionnaire or form. Although many customers find electronic forms to be more convenient than physical forms, electronic forms are not without a variety of drawbacks. For example, the information-entering process can be time consuming. Busy clients may not have the time to complete a form in a single session or may encounter a situation where it is necessary to leave a form only partially reviewed. Conventionally, however, the customer must complete and submit the electronic document in a single session or risk losing the information already entered. If the customer wants to complete the form at a second location or at a later time, the customer must re-enter information. It would therefore be desirable to provide a system and method for allowing financial customers to bookmark partially completed electronic documents in a secure manner which would allow for resumption at a later time and, optionally, at a different location, without losing previously entered information.

### SUMMARY OF THE INVENTION

Exemplary embodiments described herein overcome the drawbacks of conventional electronic document review and submission systems of financial institutions. By “bookmarking” a user's place in an electronic document and providing a user with a bookmark identifier, the below described embodiments provide for a streamlined document submission process and allow users to complete an electronic document at a later time. In addition, the below described embodiments enable a customer to partially review an electronic document at one location and pick-up at a second location without losing any previously-entered information.

In one exemplary embodiment, a computer implemented method for accessing an electronic document is provided comprising providing, by a server, an electronic document to a user of a first touchpoint device; receiving, by the first touchpoint device, an input from the user requesting a bookmark; creating a bookmark and a bookmark identifier; storing information about the electronic document in the bookmark; providing to the user, by the first touchpoint device, a bookmark identifier; entering, by the user, the bookmark identifier into a second touchpoint device; and displaying the electronic document on the second touchpoint device, wherein the electronic document displayed on the second touchpoint device has all information previously entered into the electronic document by the user using the first touchpoint device.

In another embodiment, a computer-implemented method for retrieving a previously viewed electronic document comprises receiving, at a server, identification information from a user accessing a first touchpoint device; transmitting an electronic document to the first touchpoint device for display on the first touchpoint device; receiving, by the server, a first request from the user accessing the first touchpoint device to bookmark a location in the electronic document; storing a bookmark for the location in the electronic document in a database; associating a bookmark identifier with the bookmark; storing the bookmark identifier in the database; receiving, by the server, a second request by the user accessing a second touchpoint device to present the electronic document at the location of the bookmark; receiving, by the server; a selection by the user of the bookmark identifier associated with the bookmark; obtaining, from the database, the location of the electronic document associated with the bookmark and the bookmark identifier; and transmitting, from the server to the second touchpoint device, the electronic document at the bookmarked location.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The preferred embodiments of the present invention are illustrated by way of example and not limited to the following figures:

FIG. 1 shows a system architecture according to an exemplary embodiment.

FIG. 2 is a flow chart of an exemplary embodiment.

FIGS. 3a to 3g show screen shots of a user interface on a first touchpoint device and second touchpoint device according to an exemplary embodiment

FIG. 4 shows a screen shot of a user interface on a first touchpoint device according to an exemplary embodiment.

FIG. 5 shows a screen shot of a user interface on a first touchpoint device according to an exemplary embodiment.

FIGS. 6a to 6j show a method and use of a user interface according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Exemplary embodiments, as described below, allow a user accessing a particular electronic document, such as a financial form, application or questionnaire, to partially complete the document and then resume at a later time and/or at a different location, without losing any previously entered information. For example, a bank customer reviewing a mortgage application at a bank branch could complete pages 1 through 5 of the 20 page application before realizing that he has to leave the bank to attend a meeting. By selecting the “bookmark” option, the customer may “save” his progress and location in the electronic document, and be given a bookmark identifier. When the customer desires to resume the application process, he may enter the bookmark identifier at his home computer, for example, and continue filling out the application where he left off, without losing the information entered on pages 1 through 5, and without having to go back to the bank branch.

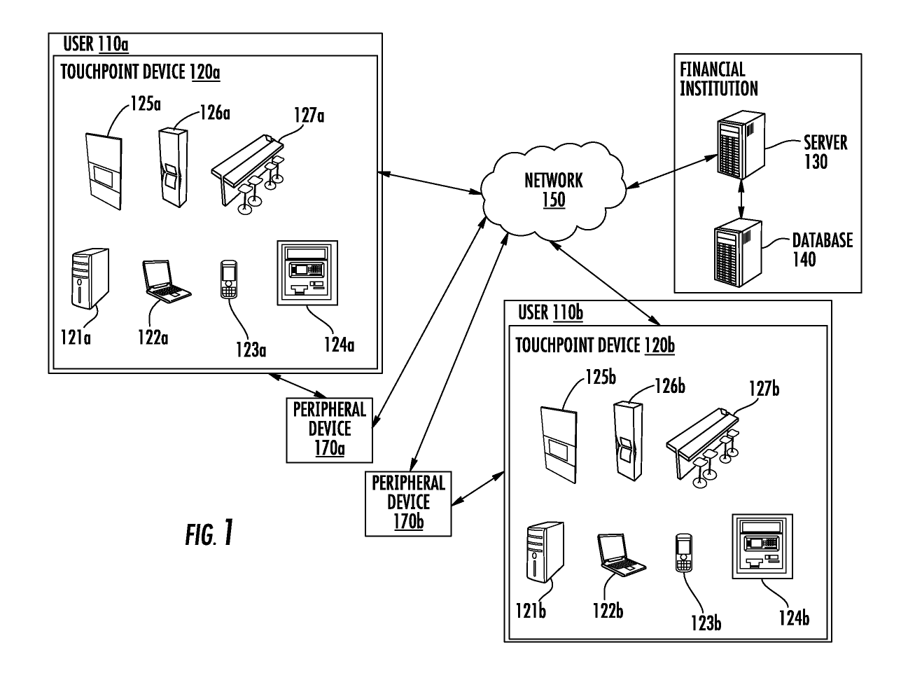

Referring to FIG. 1, a user 110a, 110b operates a first touchpoint device 120a and/or second touchpoint device 120b, such as a personal computer 121a, 121b, general purpose computer 122a, 122b special purpose computer, tablet, automated teller machine (ATM) 124, kiosk 126, 126b personal digital assistant (PDAs), wireless device, video phone, cellular or mobile phone 123a, 123b, Sales Wall 125a, 125b, Workbench 127a, 127b, or any other electronic device capable of processing data to access financial products, services, or information located on servers 130 (including processors, software, etc.) and/or databases 140 of a financial institution. Communication networks 150 such as the Internet, intranets, wireless networks, Bluetooth networks, fiber optic networks, existing telephone networks, credit networks, and other networks link the first touchpoint device 120a, second touchpoint device 120b, servers 130 and databases 140.

It will be understood that a “user” 110a, 110b of a touchpoint device 120a, 120b includes entities including, but not limited to, existing and prospective customers of financial institutions, service and sales agents, employees, managers, groups of individuals, or another entity with an existing or potential relationship with the financial institution. For example, the user can be a customer that has an account at the financial institution. In another example, the user can be a potential customer interested in obtaining a mortgage with the financial institution. In yet another example, the user can have an account at another financial institution but is using the device or services (e.g., an ATM) of another financial institution.

A user 110a can use the first touchpoint device 120a at a first instance and the second touchpoint device 120b in a second instance, whereby the user 110 is referred to as user 110b. The first touchpoint device 120a can be the same device as second touchpoint device 120b. Alternatively, first touchpoint device 120a can be a different device than second touchpoint device 120b. The types of touchpoint devices as the first touchpoint device 120a are also available as the second touchpoint device 120b.

Furthermore, it will be understood that the first touchpoint device 120a and/or second touchpoint device 120b may be physically located at a branch of a financial organization, at a user's home or office, at a transit station, a convenience store, a shopping mall, or any location where the device can be connected to a network. For example, a mobile phone 123 may access the network 150 at nearly any location in world. Alternatively, a kiosk 126 may be located at a branch of the financial institution. The kiosk 126 may be a special purpose computer comprising a display component, processing component and input component and may be programmed to display a particular GUI. Using an input device connected to the kiosk 126, the user can select, access and manipulate electronic documents. In another example, an ATM 123 can be located at a store, a branch, or almost any location throughout the world. In another embodiment, a user 110 may log on to the system using a laptop computer located at the user's place of work.

The first touchpoint device 120a and second touchpoint device 120b can include three components: (a) a processing component, (b) a display component, and (c) an input component. The processing component can include a computer processor necessary for handling the computations, processing, and other functionality of the device. The display can be a LCD, LED, OLED, CRT, 3D or stereoscopic screens, projectors, or any other type of display. The display component can be a screen capable of touch screen input. In one example, the display component, input component, and processing component may be combined into a single touchpoint device 120a, 120b to allow a user to enter information by touching the screen of the touchpoint device. Alternatively, the device can receive input from an input component instead of or in addition to a touch screen capability. Exemplary input devices may include, for example, buttons, switches, dials, sliders, keys or a keypad, a navigation pad, touch pad, touch screen, mouse, trackball, stylus, and the like, any of which can be integrated in the touchpoint device or electrically coupled thereto. The touchpoint device 120a, 120b can receive input from the input component or touch screen and display information on its display.

It will be understood that the first touchpoint device 120a and second touchpoint device 120b may be the same type of touchpoint device or different types of touchpoint devices. For example, the first touchpoint device 120a may be a general purpose computer located at a first branch of a financial institution and the second touchpoint device 120b may be a general purpose computer located at a second branch of the financial institution. As another example, the first touchpoint device 120a may be a personal computer located within a user's home and the second touchpoint device 120b may be a different computer located in the user's home. Moreover, although described as a first touchpoint device 120a and second touchpoint device 120b, it will be appreciated that the exemplary embodiments may include any number of touchpoint devices connected by a network 150, including a single touchpoint device. For example, a user may begin filling out an electronic mortgage application form on his personal laptop, but desire to finish the application later. The user 110 can request a bookmark for the mortgage application and then enter the bookmark identifier on the same laptop later to pick up the application where he left off.

Optional enhancements to the first touchpoint device 120a and/or second touchpoint device 120b can add additional service features or maintain a secure session with the user. In certain embodiments, peripheral devices 170a, 170b may be connected to, or integrated in, a touchpoint device 120a, 120b to enhance a user's experience. The peripheral devices may be connected through the network 150, though they may also be physically connected or even connected via a different network. Exemplary peripheral devices 170a, 170b may include video cameras, display devices, speakers, processors (along with software to carry out the process), input devices, biometric devices (e.g., for fingerprints, iris scan, facial recognition, voice recognition), printers, scanners, deposit/dispense devices, card readers, barcode readers (including QR code readers), PIN pads/electronic signature capture, remote camera controls, and other devices without limitation.

In one embodiment, a printer may be connected for the remote printing of documents, debit or credit cards, and/or physical representations of bookmarks such as barcodes or QR codes. In another embodiment, a scanner is present for the scanning of checks, documents, currency identification cards, etc. Additional embodiments include peripheral devices 170a, 170b such as card readers for reading magnetic strip and/or smart cards, such as credit and debit cards. In yet another embodiment, a remote camera controller is included such that, for example, a representative can control a camera connected to a touchpoint device 120a, 120v to view a customer's document. In this way, a customer could “show” the representative a certain line from a document or a specific word or letter.

In one embodiment, the user 110 may be attracted to a touchpoint device 120a located within a bank branch by a “Marketing Wall” (not shown) which is located outside the branch. The Marketing Wall comprises a display device, such as an LCD display, LED display, or OLED display and, optionally, speakers. The Marketing Wall may be programmed to display marketing materials to customers or potential customers such as promotions, ads, videos, music, and graphics in an attempt to coax the person to enter the branch. Once inside the branch, the user 110 may log in to one of a number of touchpoint devices 120a, 120b located throughout the branch including “Sales Walls” 125a, 125b and “Workbenches” 127a, 127b. A Sales Wall 125a, 125b is a display within the branch that allows the user to complete a transaction or interact with the presented information. A Workbench 127a, 127b is similar to the Sales Wall, but has a configuration of a display on a desk for user interaction.

In one embodiment, the touchpoint device 120a, 120b is a type of kiosk known as a “360 Station” 126a, 126b wherein a user 110 can conduct financial transactions such as, for example, depositing cash or checks, withdrawing cash, and/or opening or closing an account. The first touchpoint device 120a and second touchpoint device 120b described herein, including but not limited to the Sales Wall 125a, 125b, 360 Station 126a, 126b, Workbench 127a, 127b personal computer 121a, 121b, general purpose computer 122a, 122b, special purpose computer, tablet, automated teller machine (ATM) 124a, 124b, kiosk 126a, 126b, personal digital assistant (PDA), wireless device, video phone, cellular or mobile phone 123a, 123b, smart phone, and any other electronic device capable of processing data to access financial products, services, or information are all capable of being connected via the network 150 to the server 130 and database 140.

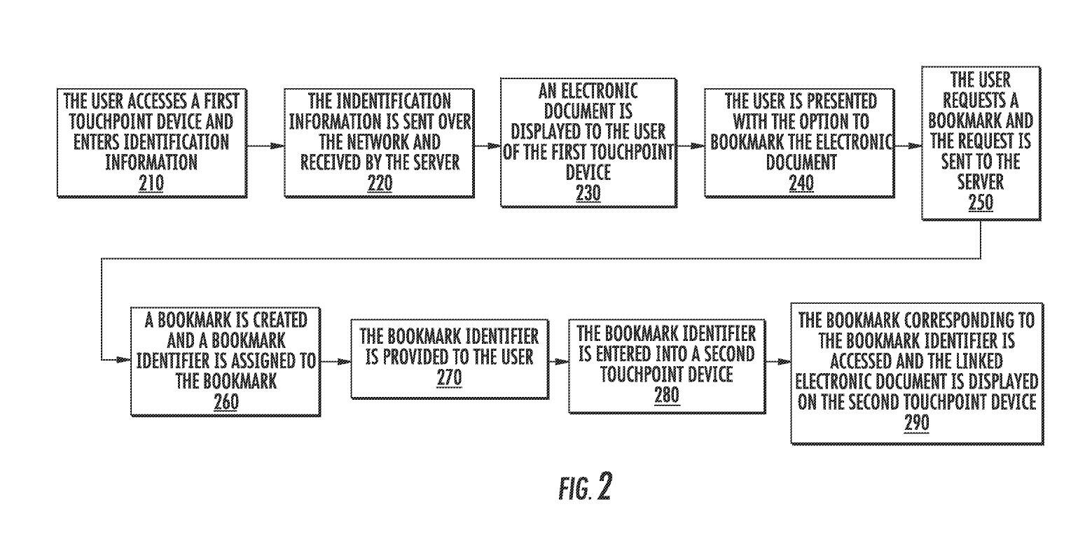

Referring to FIG. 2, an exemplary method for accessing a previously viewed electronic document is shown which uses the exemplary system of FIG. 1. It will be recognized that the exemplary method of FIG. 2 may be executed in a number of ways, and the following description should not be limited to a particular order. A user can interact with a touchpoint device to receive, review, and access information presented by the financial institution. The user may or may not be a customer of the financial institution. In the exemplary embodiment of FIG. 2, the user is an account holder of the financial institution. In an alternative embodiment where the user is not an account holder of the financial institution, the user can obtain a temporary user name and password, register for access, or proceed without entering any personal information.

At 210, a user accesses a first touchpoint device and is prompted to enter identification information. Upon input, the identification information is received by the first touchpoint device. The identification information required may be any information that identifies and verifies the user to the financial institution and may include, for example, the user's name, address, phone number, social security number, account number, pin number, age, sex, race, ethnicity, username, password, or any such information. If the user is logging into the system for the first time, the system may require the user to provide a user name and password. If the user has already established a username/password combination, the user may enter the information at a sign-on screen. Additionally, the system may prompt the user to store the username and password either locally or on the network server. In an alternative embodiment, the attached peripheral devices may be used to recognize and authenticate the user, including biometric mechanisms, such as facial recognition, retina scan, voice recognition, or a fingerprint scan.

At 220, the identification information is sent over the network by the first touchpoint device and received by a server. In one embodiment, the identification information is stored, for example, locally on the first touchpoint device. Alternatively, the identification information can be stored on the server. Once entered, the identification information may be accessed by employees of the financial institution and/or customer service representatives. Further, the identification information may be used to automatically complete electronic documents. For example, if a user fills out a credit application that requires him to enter his name and current address, the system may automatically populate that information into the application. It will be recognized that identification information will not be sent over the network if the user does not enter identification information into the first touchpoint device.

Referring to 230, an electronic document is displayed to the user on the first touchpoint device. The electronic document, such as a word processing document, web page, spreadsheet, video, picture, or any other type of electronic file that presents information to the user contains financial information, and may be any form, document, application, agreement, contract, offer, advertisement, pamphlet, manual, or product offered by the financial institution. Therefore, if an electronic document contains fields for user input, a user may enter information into the fields using the input device of the touchpoint device.

In one embodiment, the user is presented with the option to view a number of electronic documents upon logging into the system. The options displayed to the user are chosen based on a number of factors including, but not limited to, the identification information entered by the user, any stored information previously provided by the user or a third party, other electronic documents previously completed or reviewed by the user, information entered by an employee of the financial institution, or even randomly. In another embodiment, the user may log into the system to request a particular electronic document.

In a first example, the user reviews a financial institution's offerings on mortgage rates. The user can read about the different types of mortgages, such as a 30 year fixed or an adjustable rate mortgage. The user can also access available rates offered by the financial institution. The financial institution can also present a calculator to allow the user to determine a monthly payment based on various configurations. If the user has decided on a particular mortgage product, the user can fill out a mortgage application.

Once the user begins entering information into the fields of the electronic document or, if the electronic document does not contain data fields to be completed, the user begins reading the electronic document, he will be presented with the option of creating a bookmark 240. It is appreciated that the option to bookmark a document may be presented or enabled at any time after an electronic document is selected to be viewed, including but not limited to, immediately after the document is selected, upon a set period of time, within a certain amount of time after the user becomes idle or upon an attempted exit from the document.

As used herein, the term “bookmark” may refer to any number of digital embodiments which may be stored on the server in, for example, a bookmark database in order to allow a user to continue viewing the electronic document at the same place and status of the electronic document at a later time and/or on a different touchpoint device. In one embodiment, each bookmark comprises a number of links to other documents. For example, the bookmark may contain a link to a copy of the electronic document file, the electronic document file itself, a bookmark identifier, a file containing information about the electronic document, the identification information, and other documents and/or databases. A database of the financial institution can store the bookmark, the bookmark identifier, and any additional information associated with bookmarks.

If the electronic document contains data entry fields, the bookmark may link to a separate file containing any data entered by the user at the time the bookmark option was selected. The data may be correlated to the appropriate data field in the electronic document by any means known in the art including, but not limited to, storing the data and corresponding location in one or more databases or files.

Additionally, the bookmark may link to a file containing additional information about the electronic document such as the title, date, total pages, the current page being viewed when the bookmark option was selected, any annotations made by the user, total views, and other information identifying the document such as but not limited to the document number or form number. In another embodiment, the bookmark is the electronic file itself.

For example, the bookmark may mark a location within a webpage. In another example, a bookmark may mark a location in a partially completed form. In this example, a user can continue to complete the form from another touchpoint device without re-entering the previously completed fields. In yet another example, the bookmark can mark a stage of a process so that the user can continue the process at a later time or on another touchpoint device.

When the user inputs a selection into the first touchpoint device requesting a bookmark, the request is received by the server via the network 250. As an example, the first touchpoint device may contain a physical button labeled, e.g. “Create Bookmark.” Upon pressing the “Create Bookmark” button, a request is sent by the first touchpoint device through the network, and received by the server. In another example, the first touchpoint device may contain a digital button or icon displayed within a graphical user interface displayed on the first touchpoint device. In still other embodiments, voice recognition and interactive voice response is incorporated such that the user may simply say, e.g., “Create Bookmark.”

Once a request for a bookmark is received by the server, a bookmark is created and a bookmark identifier is assigned to the bookmark 260. A bookmark identifier is a means by which the bookmark may be accessed, located, found, or read from the server by a touchpoint device. When the bookmark identifier is entered into a touchpoint device, the server may access the previously-created, corresponding bookmark. For example, a bookmark identifier may be the filename of the bookmark or a shortcut to the bookmark. In one embodiment, bookmark identifier may be stored in a bookmark identifier database wherein each bookmark identifier is correlated to a filename and/or path/location of a corresponding bookmark.

The bookmark identifier can be a representation of the bookmark. The database of the financial institution can associate the bookmark identifier with the bookmark. The bookmark identifier can be used by the user to recall the previous location within an electronic document. As a result, the bookmark identifier can be a character or string of characters, such as a number(s) or letter(s), that can be easier for the user to correlate with the saved location. However, the bookmark identifier can include any one or combination of numbers, letters, characters, icons, pictures, symbols, or other representation. Alternatively, the bookmark identifier may be a barcode or a QR code. In all of the above mentioned embodiments, the bookmark identifier may be randomly generated and assigned by the system, systematically generated and assigned by the system, selected by a user, or assigned by a user. For example, the first time a user selects the bookmark option, the bookmark identifier assigned may be the number “1.” The second time the user selects the bookmark option, the bookmark identifier assigned may be the number “2,” etc. In another example, the system may ask the user to enter the bookmark identifier and then assign the user input as the bookmark identifier.

At 270 the bookmark identifier is provided to the user. In one exemplary embodiment the bookmark identifier is physically printed by an attached printer such that the user may carry the printout of the identifier with him. For example, if the bookmark identifier is a barcode corresponding to a series of numbers and/or letters, an attached printer may print the barcode onto, e.g., a piece of paper or receipt. The user may then scan the printed barcode into a second touchpoint device using an attached barcode reader or digital camera, which may translate the barcode back to numbers and/or letters to access the bookmark. As another example, if the bookmark identifier is a QR code printed on a piece of paper or receipt, the user may take a picture of the code with his mobile phone and, using provided or third party software, access the bookmark through the internet. It will be appreciated that a user may simply read the printed bookmark identifier and manually enter the same into a second touchpoint device using an attached input component, such as a keyboard, pin-pad, or touch screen.

In another embodiment the bookmark identifier may be maintained in a digital format such that it may be sent electronically to the user by, for example, email, text message, picture message, instant messenger, Bluetooth® wireless, RFID technology or other known methods. As one example, if the bookmark identifier is a barcode, the barcode may be emailed to a user and then either printed out by the user to be scanned into a second touchpoint device or simply displayed to a video camera or barcode scanner attached to the second touchpoint device. Alternatively, if the bookmark identifier is, for example, emailed to a user, the user may simply display the barcode on his PDA or mobile phone's display device in order to scan the barcode into a second touchpoint device having a barcode scanner or camera.

In another embodiment, the bookmark identifier can be digitally stored on a digital medium such as a CD-ROM, DVD, Flash Memory device, smart card, magnetic strip card, RFID chip, or the like provided by either the user or the financial institution. The digitally stored bookmark identifier may be read by a second touchpoint device that is sufficiently equipped to read the medium. In another embodiment, the digital bookmark identifier is merely displayed to the user on the first touchpoint device and either written down by the user or remembered.

At 280, the bookmark identifier is entered by the user into the second touchpoint device and the previously-stored bookmark is accessed. In one embodiment, a user is prompted by the second touchpoint device to enter the bookmark identifier at any time upon accessing the second touchpoint device. Once prompted, the user may enter the bookmark identifier using the input component of second touchpoint device. It will be appreciated that the manner of entering the bookmark identifier into the second touchpoint device will depend upon the embodiment of the bookmark identifier. For example, if the bookmark identifier is a printed barcode, the user may scan the barcode into the second touchpoint device. Alternatively, if the bookmark is a number or word, the user may use an attached keyboard, pin-pad, or touch screen to enter the number or word. It will also be appreciated that, as discussed above, the first touchpoint device and second touchpoint device may be the same touchpoint device.

At 290, the bookmark corresponding to the bookmark identifier is accessed and the linked electronic document is displayed to the user on the second touchpoint device. In one embodiment, the bookmark identifier database is accessed, the entered bookmark identifier is located in the database, and the corresponding bookmark is determined. The bookmark links to the partially completed electronic document, and the document is sent from the server via the network to the second touchpoint device.

In another embodiment, the bookmark identifier database and the bookmark database are one in the same. Once the entered bookmark identifier is located within the bookmark identifier database, the corresponding bookmark and electronic document may be accessed and the electronic document may be sent to the second touchpoint device. In an alternative embodiment, the bookmark identifier is a shortcut to the filename and file path of the electronic document.

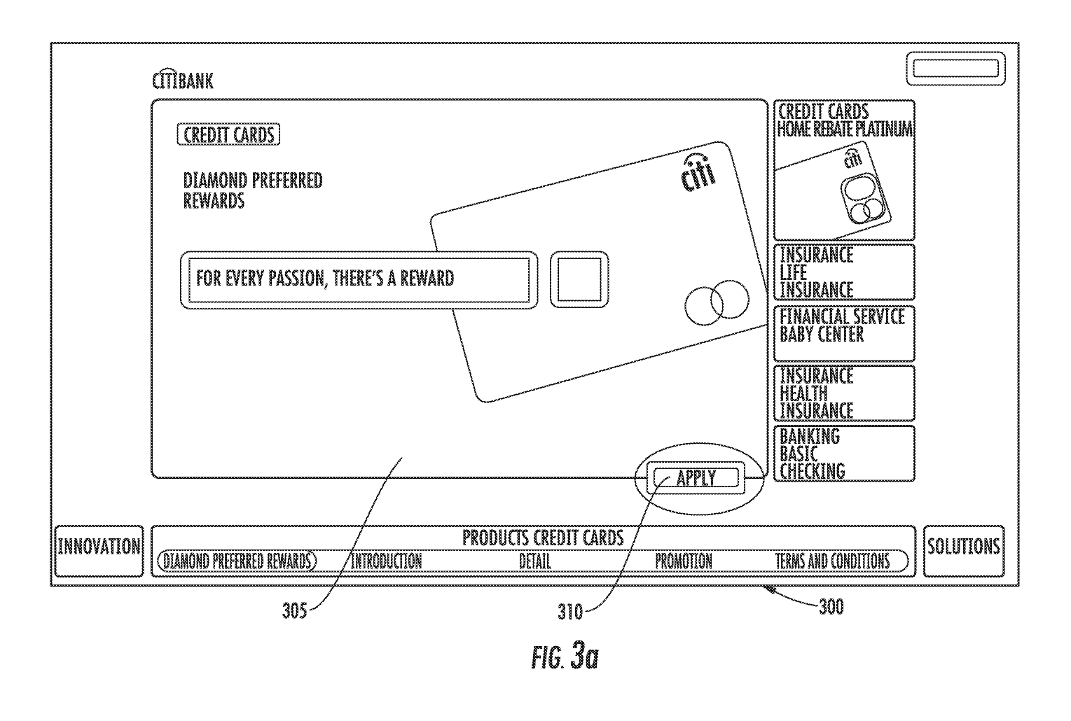

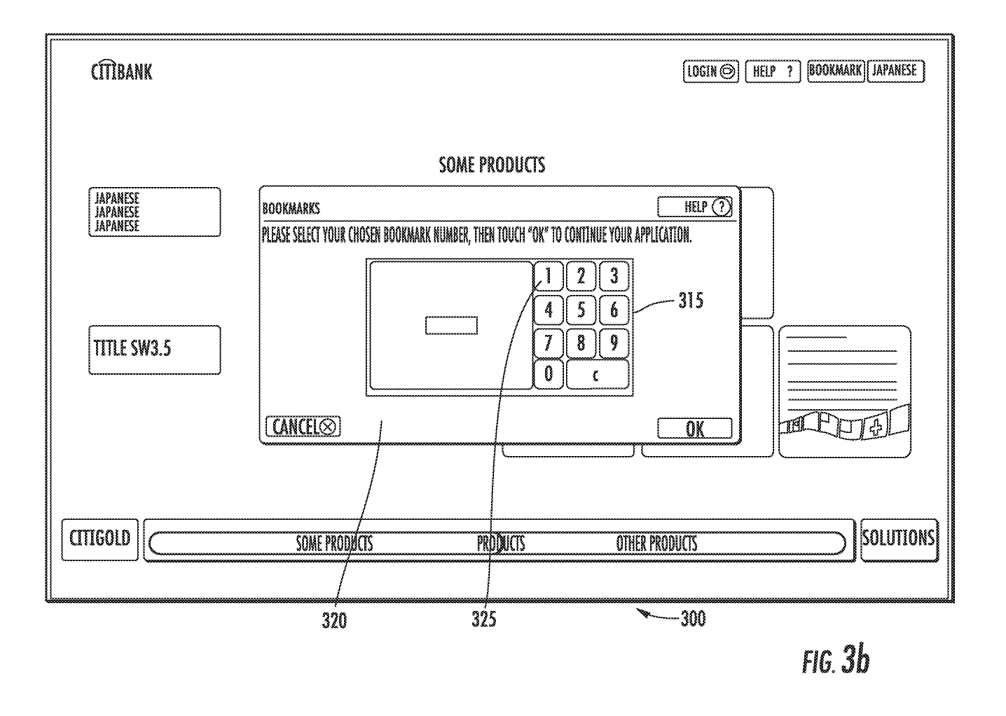

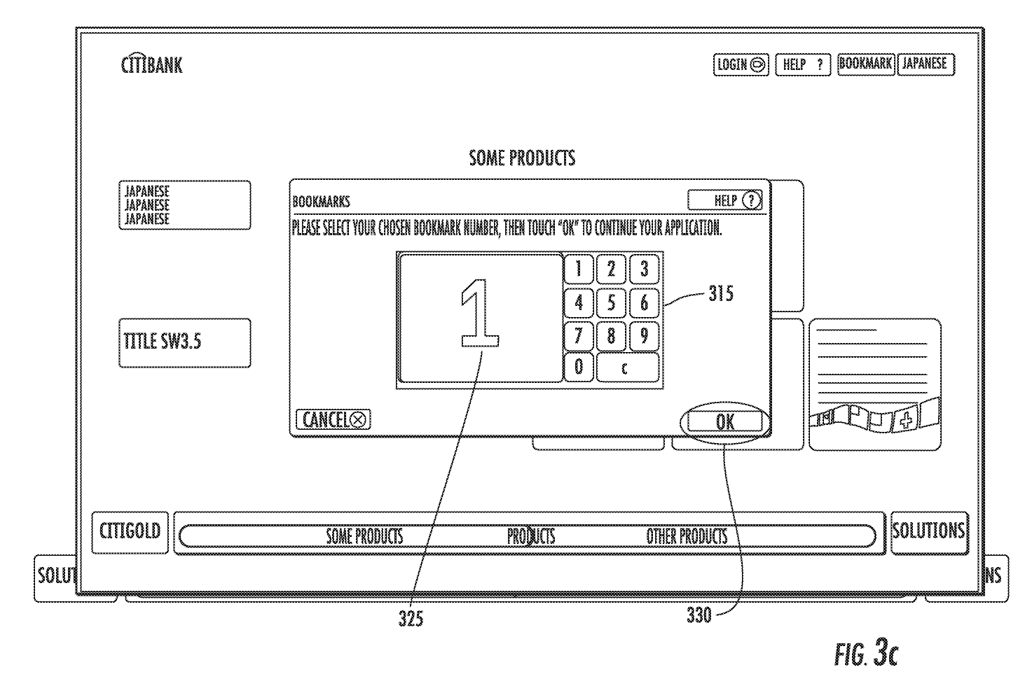

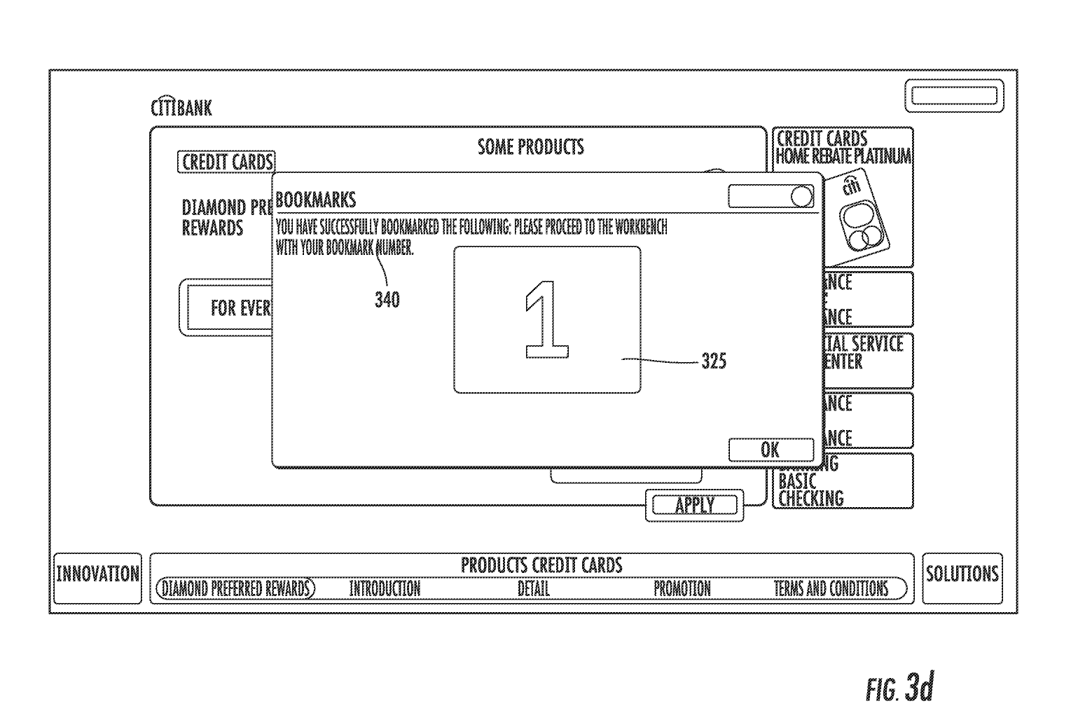

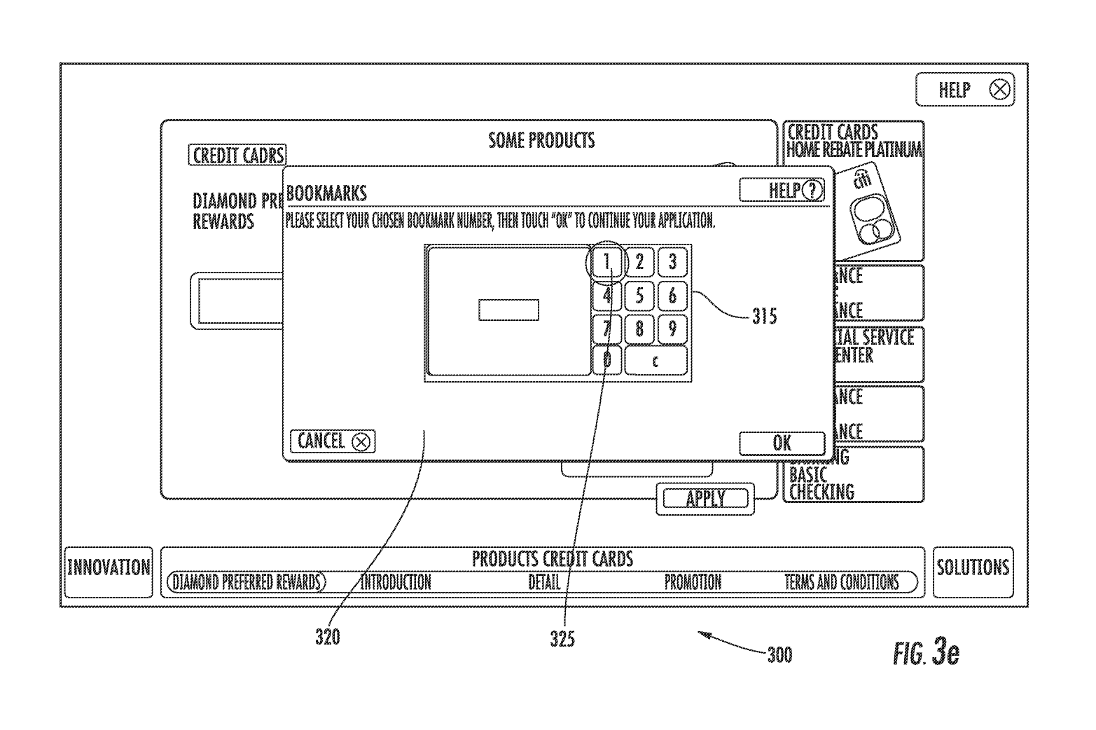

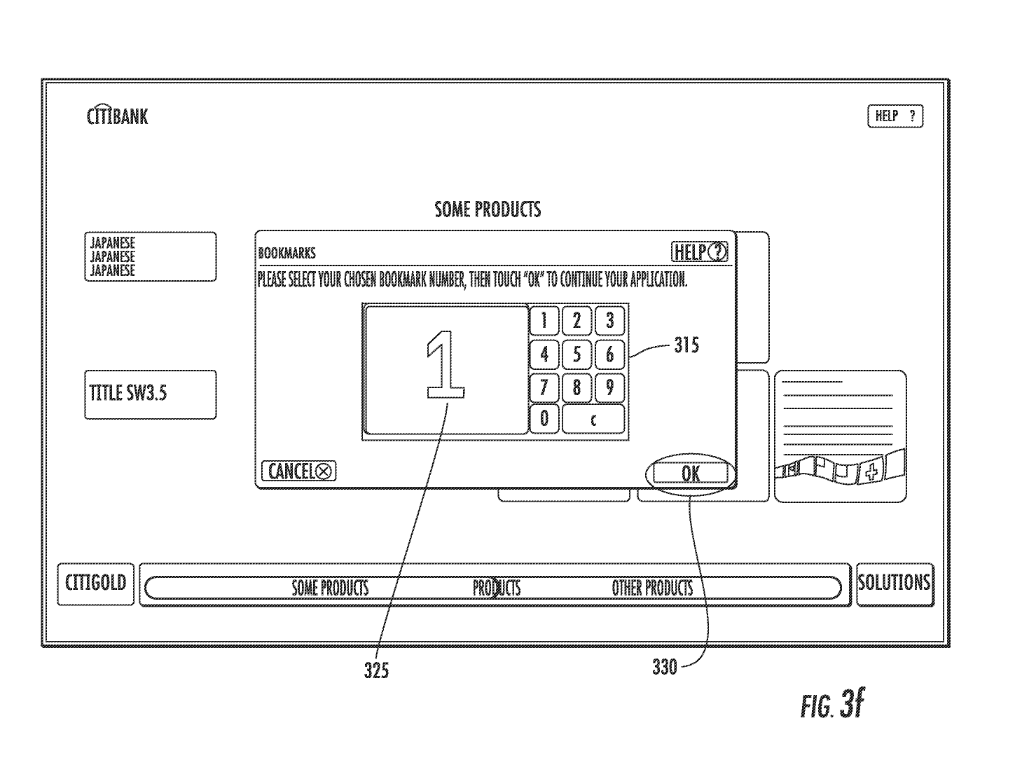

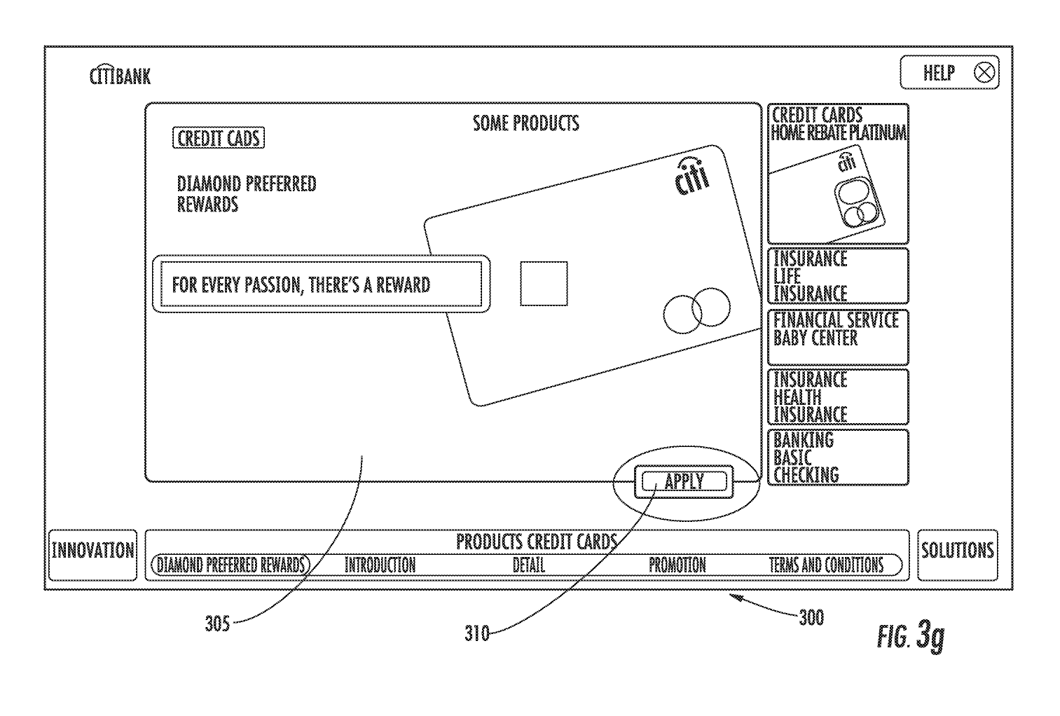

Referring to FIGS. 3a to 3d, screenshots of a customer user interface according an exemplary embodiment are shown. As shown in FIG. 3a, a user of a first touchpoint device, such as a 360 station or mobile phone, is reviewing an electronic document 305 having information about Diamond Preferred Rewards on a graphical user interface 300 presented on the screen of the first touchpoint device. At any point during the session, the user may apply for the Diamond Preferred Reward card shown on the electronic document 305. In this example embodiment, the user may touch the screen of the user interface 300 to select the image, button, or link labeled “Apply” 310.

In FIG. 3b, once the user has selected the “Apply” button 310, the user interface 300 presents the user with the option to bookmark the electronic document 305. The option is presented to the user in a single window 320, which can be integrated into the user interface 300. The user is given the choice of assigning a bookmark identifier to the bookmark by entering a bookmark number 325 on a keypad 315 using an input component of the touchpoint device. In this exemplary embodiment, the user may touch the screen of the user interface 300 to select the image, button, or link labeled with the corresponding number the user desires to use as the bookmark number 325.

In FIG. 3c, the user has entered the bookmark number 325 “1” by touching the appropriately labeled image, button, or link. The bookmark number 325 is displayed to the user in the window. In order to accept the bookmark number 325, the user may select the image, button, or link labeled “OK” 330. This selection of a bookmark number 325 is transmitted from the touchpoint device to the financial institution's server, which saves the bookmark number 325 along with information associated in with the bookmark in a database.

In FIG. 3d, the user interface 300 displays the phrase, “You have successfully bookmarked the following. Please proceed to the Workbench with your Bookmark Number” 340 within the window 320. Additionally, the user interface 300 displays the bookmark number 325 to the user. The user may now enter the bookmark number 325 at a second touchpoint device, such as a Workbench, to continue applying for the Diamond Preferred Reward Card. Alternatively, the user could continue working on the first touchpoint device. It will be appreciated that the user may enter the bookmark number 325 into any second touchpoint device, and the Diamond Preferred Rewards application will be displayed to the user.

As shown in FIG. 3e, a user can choose to return to a bookmarked location by selecting a link for bookmarks. A window 320 is presented on the user interface 300 that asks the user to “Please select your chosen Bookmark Number, then touch ‘OK’ to continue to your Application.” Based on the earlier example, if the user previous used a “1” for a desired bookmark, the user would enter a “1” here by selecting from the bookmark number 325 from a keypad 315 via an input component associated with the touchpoint device.

In FIG. 3f, once the user selects the bookmark number, it is displayed on the window 320. As shown in this example, the user selected “1” as the bookmark number 325. If this bookmark number 325 is correct, the user can click the “OK” button to proceed. Then, the financial institution's server receives the bookmark number 325 from the touchpoint device and retrieves the information associated with the bookmark that is stored in the database.

In FIG. 3g, the bookmarked electronic document 305 showing the Diamond Preferred Rewards offer is displayed for the user on the user interface 300 in the same configuration and status as when the user previously reviewed and bookmarked this electronic document, as discussed with respect to FIG. 3a. The electronic document is operational and allows the user to select the “Apply” button 310 to proceed with the offer. The ability to bookmark this offer and return to the same location can be particularly convenient if the user is reviewing the offer in one location (e.g., a branch) and then decides to continue reviewing the offer while en route (e.g., via a mobile phone) to another location (e.g., an office), where the user can still continue to review the same offer (e.g., from a personal computer).

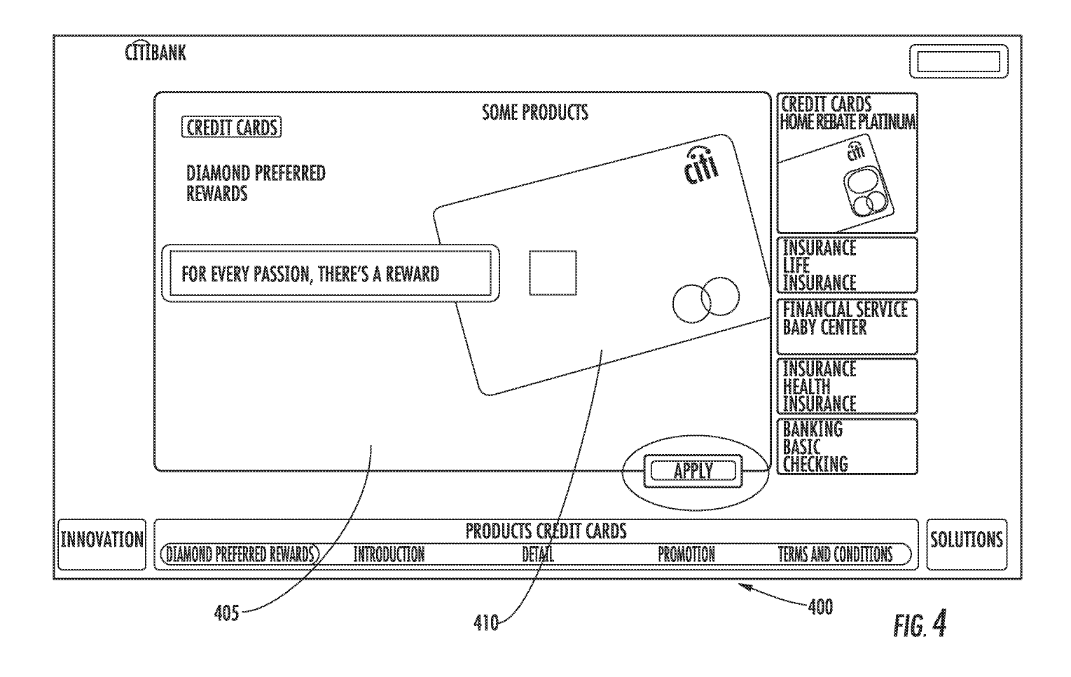

In another embodiment, as shown in FIG. 4, a bookmark identifier 410 on a electronic document 405 of a user interface 400 can be used to recall that electronic document at a later time or on a different touchpoint device. The bookmark identifier 410 can be added to the electronic document 405 upon a request by the user or it can be automatically generated and displayed for the current electronic document 405 being viewed by the user. Alternatively, the user interface can be configured to provide bookmark identifiers for only certain or periodic electronic documents (e.g., every other website) viewed by the user.

In this exemplary embodiment, the bookmark identifier 410 is a QR code. A QR code is a matrix code or two-dimensional bar code. The QR code can store an address or URL. Some mobile phones with cameras have the capability to read QR codes. Other devices can also be adapted to provide this capability. A mobile phone with a camera and special purpose software can scan the image of the QR code and cause a browser on the mobile phone to launch and redirect to the programmed URL. Although a QR code is shown in this exemplary embodiment, the bookmark identifier 410 can also be a micro QR code, a design DR, or a bar code.

When reviewing the electronic document 405, the user may decide to bookmark this location for a visit at a later time or on another touchpoint device. The user would use a mobile phone having a camera and capture an image of the user interface 400 having the bookmark identifier 410. Using special purpose software installed on the mobile phone, the user can scan the bookmark identifier 410 to obtain a URL corresponding to the electronic document. The user can then access the URL from a browser on the mobile phone or access the URL from another touchpoint device.

In another example, the user can capture the bookmark identifier 410 using a mobile phone having a camera. The user can then display the bookmark identifier 410 on the screen of the mobile phone. A touchpoint device having a scanner can capture the bookmark identifier 410 from the screen of the mobile phone. The touchpoint device can then read the bookmark identifier 410 and load a browser with the corresponding URL.

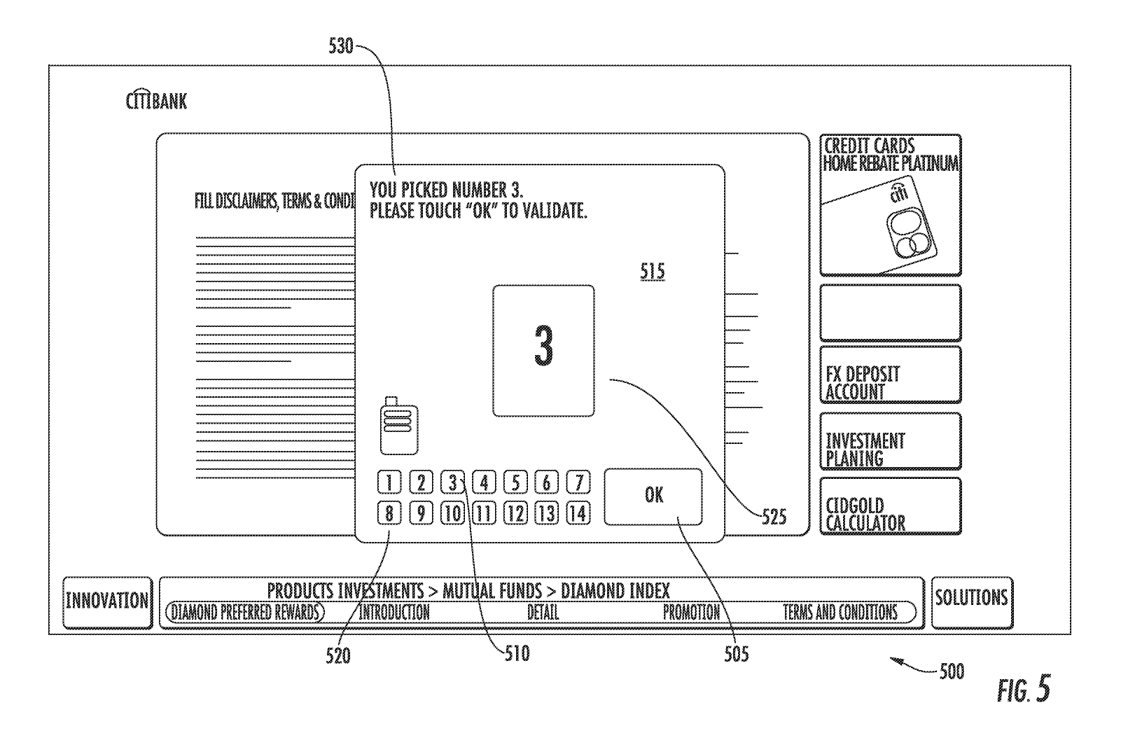

Referring to FIG. 5, a screenshot of a customer user interface according an exemplary embodiment is shown. In this embodiment, a user has inputted a bookmark identifier 510 into a bookmark selection window 515 of a user interface 500 on a touchpoint device. The user in this exemplary embodiment has selected the number “3” by touching a numeric pad populated within a first portion 520 of the bookmark selection window 515. Once selected, the number corresponding to the bookmark identifier 510 may be highlighted within the numeric pad. In this example, the “3” button or link is highlighted in the color green, although it will be appreciated that any color or method of highlighting the button or link may be implemented. The bookmark identifier 510 may then be displayed within a second portion 525 of the bookmark selection window 515. Moreover, a status update 530 may be displayed to the user indicating which bookmark identifier 510 was selected. In this particular embodiment, the system displays a status update 530 with the following text: “You picked number 3.” By selecting a confirmation button or link 505, such as the button/link labeled “OK,” the user can confirm the bookmark identifier 510 selection.

In one exemplary embodiment, the keys of the numeric keypad may be grayed-out, dimmed, or changed in color depending on the status of the bookmark identifier 510 to which each key corresponds. For example, the “2” key, button or link located on the numeric pad in FIG. 5 is grayed-out, indicating that the user has already assigned that bookmark identifier 510 to an electronic document. Therefore, the “2” key is not available as a bookmark identifier 510. Alternatively, the numbers 1, 5, 8, 9, 12, and 14 are not grayed-out, and are therefore available to be selected as a bookmark identifier 510. Although the keypad is shown with numbers, it will be appreciated that any type of keypad may be populated within a first portion 520 of a bookmark selection window 515, including a full QWERTY keyboard, a keypad in any language, or a keypad with icons. Additionally, although described herein as a first portion 520 and second portion 525, it will be appreciated that the bookmark selection window 515 may comprise any number of portions, including only a single portion.

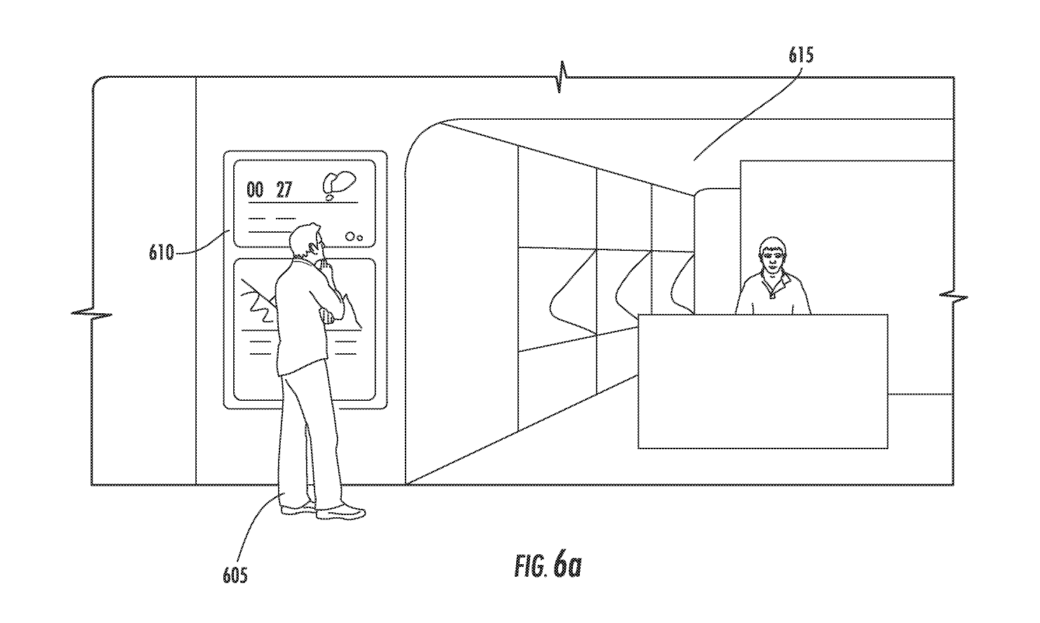

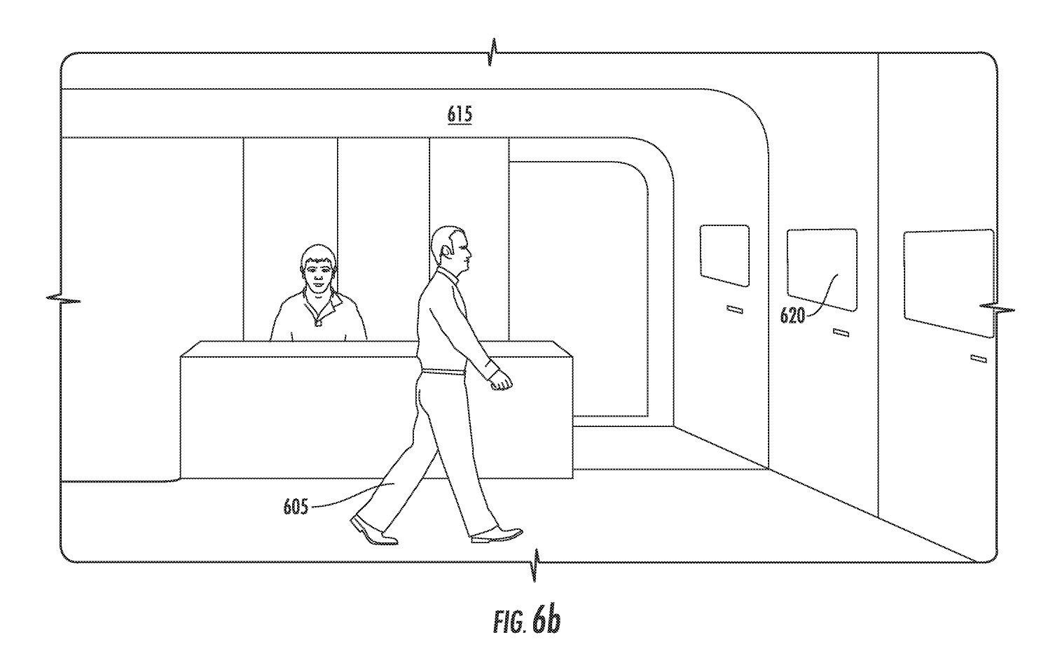

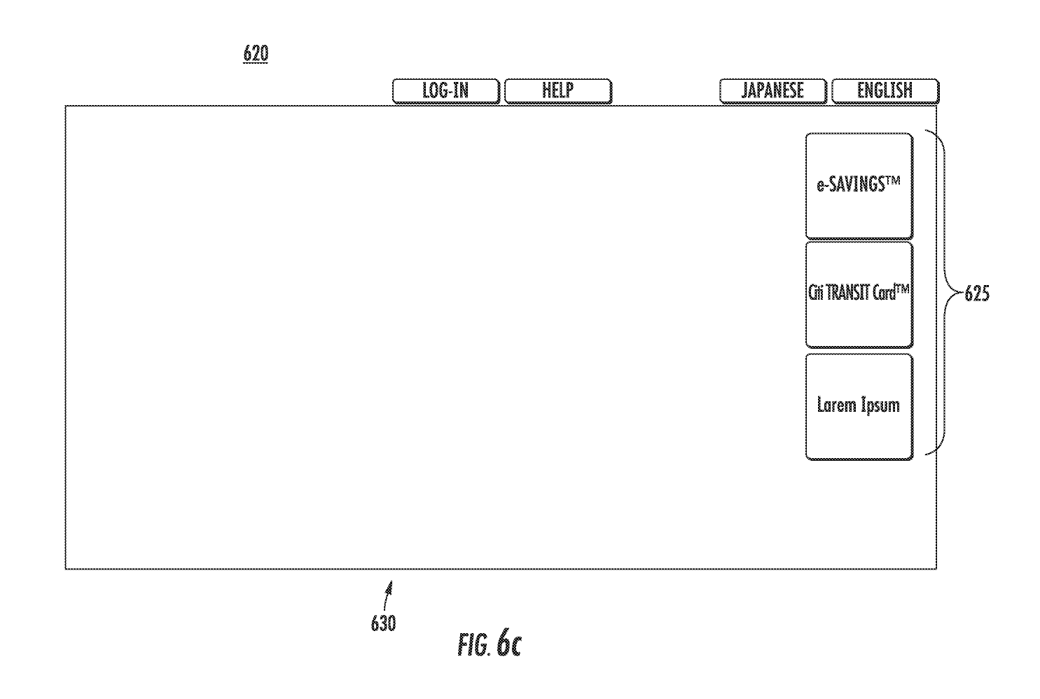

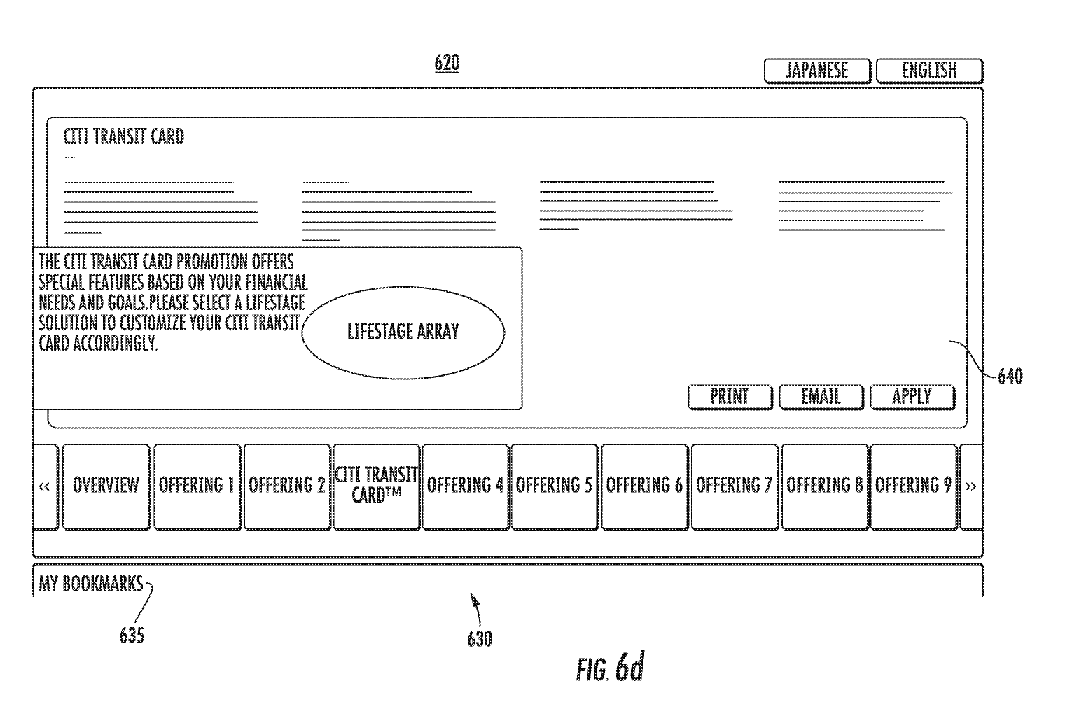

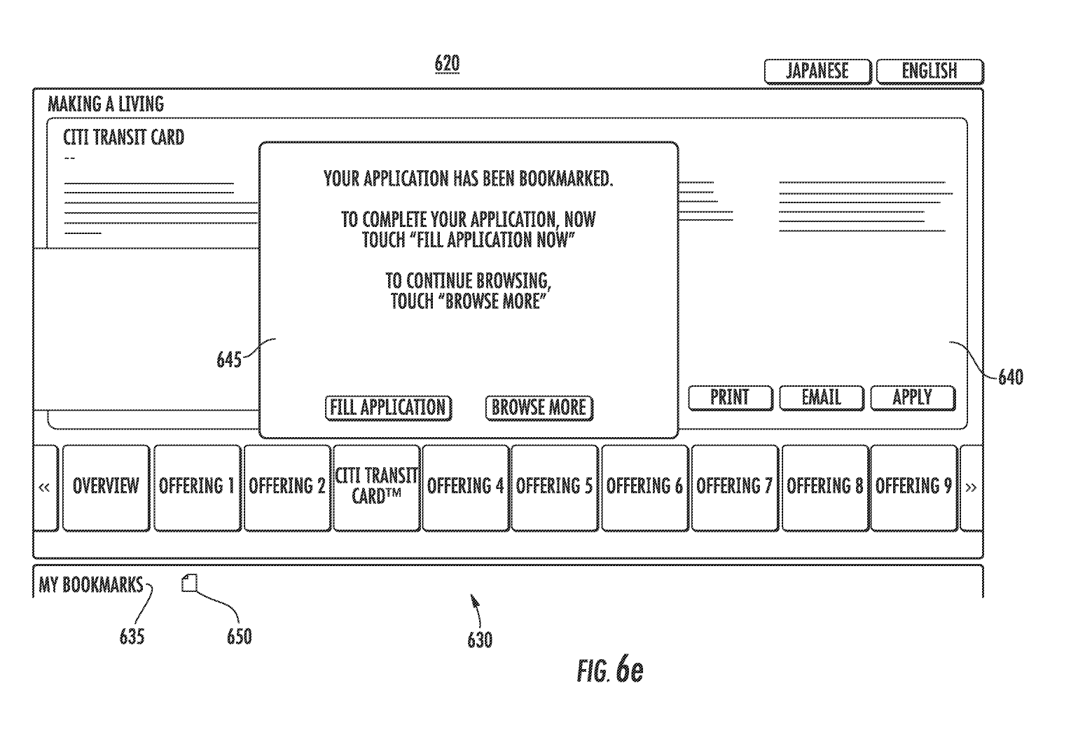

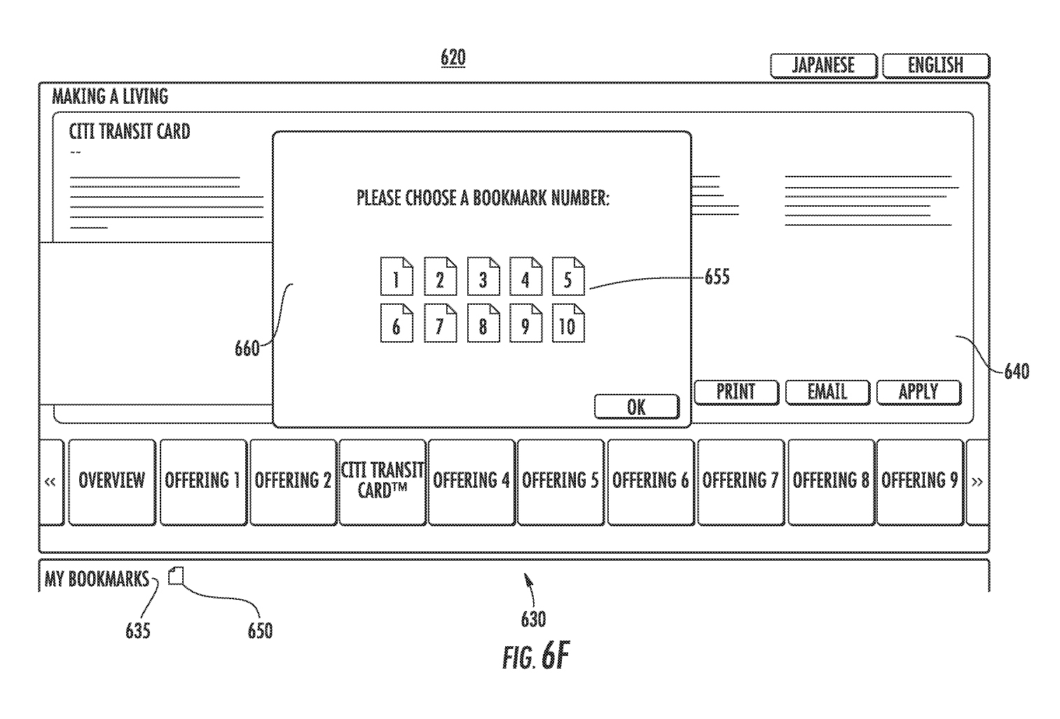

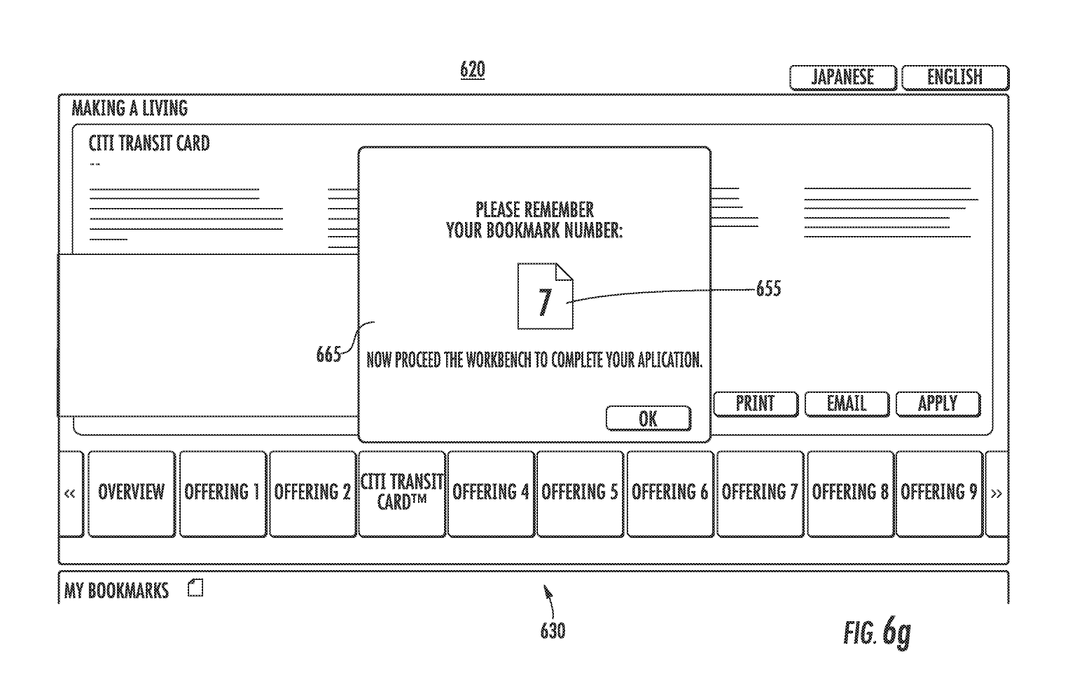

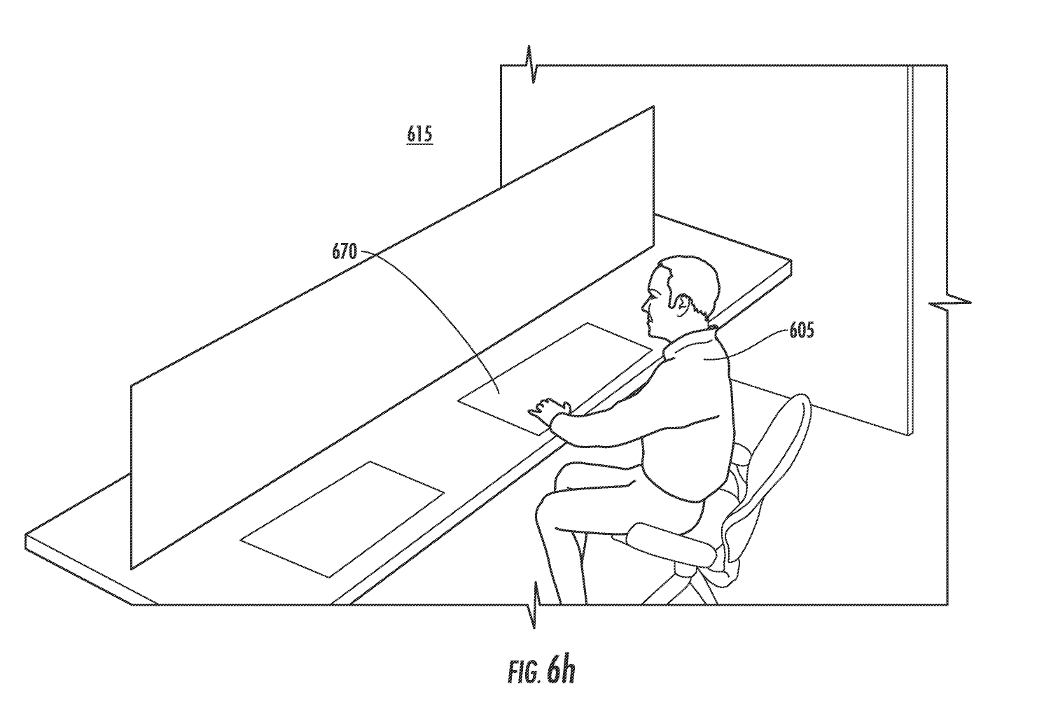

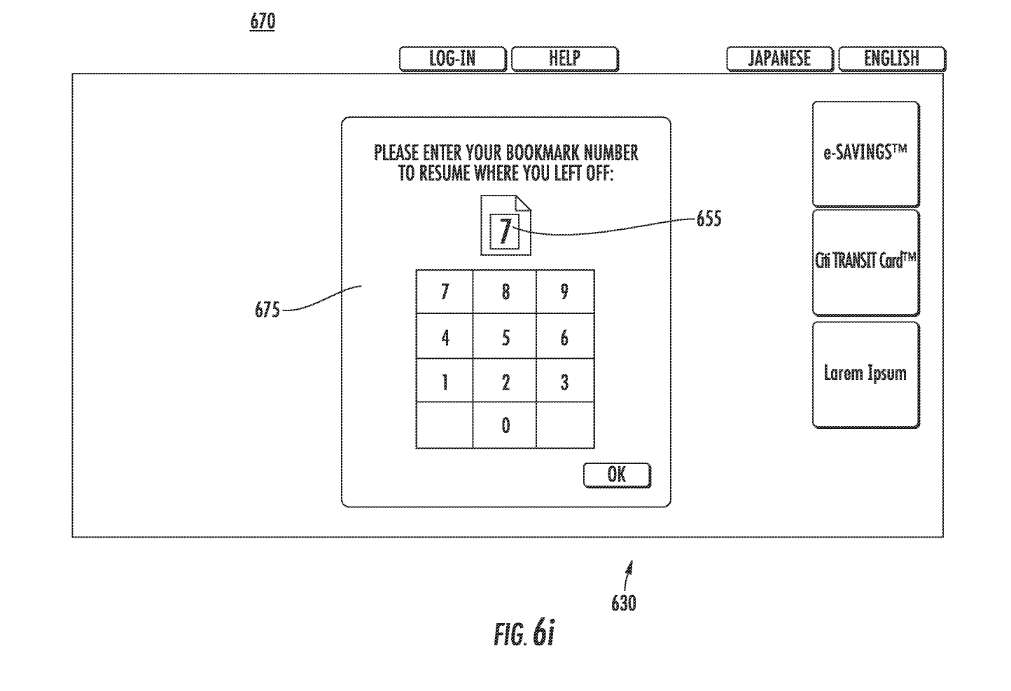

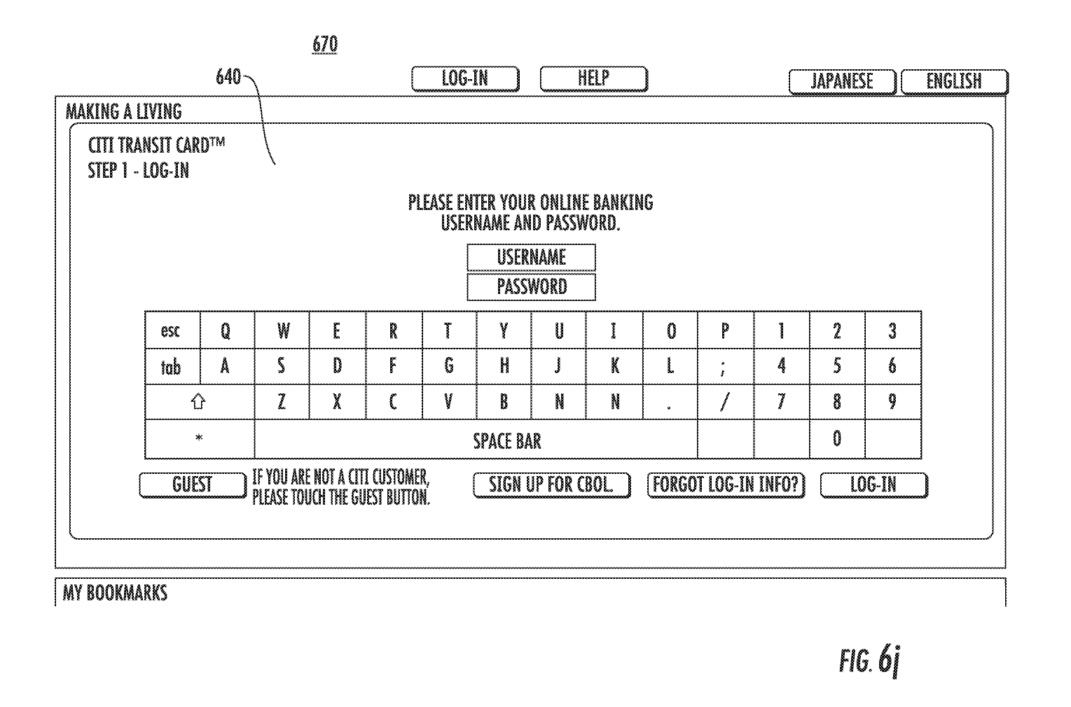

Referring to FIGS. 6a through 6j an exemplary method and use of a user interface are shown. First, at FIG. 6a, a user 605 is attracted to a Marketing Wall 610, which is located outside of, or within close proximity to, a financial institution 615. The Marketing Wall 610 may be programmed to display special offers, promotions, advertisements, images, videos, and/or sounds to attract customers to the financial institution 615. In this exemplary embodiment, the Marketing Wall 610 displays a credit card promotion such as a Citi TRANSIT Card Promotion.

At FIG. 6b, the user 605 decides to enter the financial institution 615, and approaches a Sales Wall 620. As shown in FIG. 6c, the Sales Wall 620 may run an “attract loop,” such that images, videos, and/or audio are displayed to attract a user to the Sales Wall 620. In this exemplary embodiment, the Sales Wall 620 displays a number of promotions or advertisements in a promotions bar 625 located within a graphical user interface 630 of the Sales Wall 620. Included among the available promotions or advertisements displayed may be the same promotion or advertisement which is displayed on the Marketing Wall 610. In this example, the “Citi TRANSIT Card Promotion” is displayed within the promotions bar 625. By selecting a button or link in the promotions bar 625, a user may retrieve and display an electronic document corresponding to that button or link. For example, if the user selects the Citi TRANSIT Card Promotion button or link, an electronic document containing information about that promotion may be displayed on the Sales Wall 620.

At FIG. 6d, the “attract loop” has ended, as the user has selected the “Citi TRANSIT Card Promotion” link. An electronic document 640 is displayed to the user with information pertaining to the Citi TRANSIT credit card. The user may now review the information and decide whether to print/email the application, or begin the application process. In one embodiment, a bookmark display bar 635 labeled “My Bookmarks” in this particular example is displayed within the user interface 630. The bookmark display bar 635 may contain information about any bookmarks the user has previously stored. In this particular embodiment, no information is displayed, as the user has not yet bookmarked an electronic document 640.

At FIG. 6e, the user has inputted a selection to apply for the Citi TRANSIT credit card, and a bookmark confirmation window 645 is automatically displayed within the user interface 630 informing the user that the application has been bookmarked. In one embodiment, a bookmark is created and stored by the server. The bookmark may contain any data previously entered into the system and, additionally, information about the electronic document 640 being viewed by the user. Alternatively, the bookmark may contain a copy of the electronic document 640.

The user is presented with the option to either fill out the Citi TRANSIT credit card application or continue browsing without filling out the application. Notably, a selectable bookmark icon 650 has been added to the bookmark display bar 635, indicating that the server has stored at least one bookmark for the user. In this particular example, the bookmark is linked to the Citi TRANSIT credit card application. If the user selects to continue browsing, the user may select the bookmark icon 650 at any time to return to the application.

In one embodiment, a bookmark may be automatically assigned and linked to an electronic document 640. It will be appreciated, however, that in alternative embodiments, a bookmark may not be assigned to an electronic document 640 until a request is received from the user, or until another predetermined time.

At FIG. 6f, the user has selected to continue filling out the application 640, and a bookmark selection window 660 is presented to the user with a number of bookmark identifier 655 options. The user may select any of the non-faded icons to assign as a bookmark identifier 655 corresponding to the bookmark icon 650. In this way, the bookmark identifier 655 will be assigned to a bookmark, which may link to the application 640 that the user is viewing.

At FIG. 6g, once the user selects a bookmark identifier 655, that bookmark identifier may be displayed to the user in, for example, a bookmark identifier display window 665 such that the user may remember or write down the bookmark identifier 655. As previously discussed above, in alternative embodiments, the bookmark identifier may be sent to the user electronically via any means known in the art or printed out for the user via an attached printer. Additionally, a message may be displayed to the user within the bookmark identifier display window 665 issuing instructions such as: “Now proceed to the Workbench to complete your application.”

At FIG. 6h, the user 605 moves from the Sales Wall 620 to a Workbench 670, and at FIG. 6i, a graphical user interface 630 is displayed on the Workbench 670. A bookmark input window 675 is displayed within a user interface 630 of the Workbench 670, and the user is prompted to enter a bookmark identifier 655. In this example, the user may enter the bookmark identifier 655 previously selected and stored on the system at the Sales Wall 620. The bookmark identifier 655 is displayed on the screen within the bookmark input window 675.

At FIG. 6j, a bookmark corresponding to the entered bookmark identifier 655 is retrieved from the server, and the linked electronic document is displayed on the Workbench 670. In this particular embodiment, the Citi TRANSIT Card application is displayed on the Workbench 670 for the user to complete.

It will be appreciated that the bookmark and electronic document may be accessed by any touchpoint device connected to the server by entering the bookmark identifier. It will also be appreciated that, as discussed above, the first touchpoint device and second touchpoint device may, in fact, be the same device. Further, an additional bookmark and bookmark identifier may be created using the second touchpoint device if the user wishes to access the electronic document at a later time or from a third touchpoint device. There are no limitations to the amount of bookmarks, sessions, or touchpoint devices that may be used to access an electronic document.

As described in some embodiments, a web browser (e.g., Microsoft Internet Explorer, Mozilla Firefox, Apple Safari, or Google Chrome) is not required to store a location within an electronic document, even though that electronic document is accessed over a network such as the internet. The user can mark a location for later viewing and later retrieve that location in an electronic document without using a web browser or the bookmarking feature provided by a conventional web browser. Whereas a web browser uses a bookmark to store a website address, the embodiments described herein can store a particular page or section of an electronic document as well as a particular view, a specific location within the page or section, and any completed fields.

Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that there are numerous alternative components and embodiments that may be substituted for or included in the particular examples described herein and such additions or substitutions still fall within the scope of the invention.

What is claimed is:

1. A computer-implemented method for accessing an electronic document comprising:
providing, by a server, an electronic document to a user of a first touchpoint device;
receiving, by the first touchpoint device, an input from the user requesting a bookmark;
creating a bookmark and a bookmark identifier;
storing information about the electronic document in the bookmark;
providing to the user, by the first touchpoint device, a bookmark identifier;
entering, by the user, the bookmark identifier into a second touchpoint device; and
displaying the electronic document on the second touchpoint device,
wherein the electronic document displayed on the second touchpoint device has all information previously entered into the electronic document by the user using the first touchpoint device.

2. The computer-implemented method according to claim 1, wherein the first touchpoint device is the same as the second touchpoint device.

3. The computer-implemented method according to claim 1, wherein the first touchpoint device or the second touchpoint device is selected from a mobile phone, automated teller machine, kiosk, or personal data assistant.

4. The computer-implemented method according to claim 1, wherein the first touchpoint device or the second touchpoint device is selected from a personal computer or a tablet computer.

5. The computer-implemented method according to claim 1, wherein the bookmark identifier comprises a symbol, letter, number, character, icon, picture, bar code, or QR code.

6. The computer-implemented method according to claim 1, wherein creating the bookmark identifier comprises the server automatically generating a bookmark identifier for the electronic document.

7. The computer-implemented method according to claim 1, further comprising receiving a selection by the user of a bookmark identifier for the electronic document.

8. The computer-implemented method according to claim 1, further comprising:
receiving input from the user in a field in the electronic document on the first touchpoint device;
storing the input in the database; and
providing the electronic document to the user on the second touchpoint device with the input received from the user.

9. The computer-implemented method according to claim 1, further comprising:
associating the bookmark at a designated point in the electronic document; and
when the user approaches the designated point in the electronic document, requesting the user to continue reviewing the electronic document at the second touchpoint device.

10. A computer-implemented method for retrieving a previously viewed electronic document, the method comprising:
receiving, at a server, identification information from a user accessing a first touchpoint device;
transmitting an electronic document to the first touchpoint device for display on the first touchpoint device;
receiving, by the server, a first request from the user accessing the first touchpoint device to bookmark a location in the electronic document;
storing a bookmark for the location in the electronic document in a database;
associating a bookmark identifier with the bookmark;
storing the bookmark identifier in the database;
receiving, by the server, a second request by the user accessing a second touchpoint device to present the electronic document at the location of the bookmark;
receiving, by the server; a selection by the user of the bookmark identifier associated with the bookmark;
obtaining, from the database, the location of the electronic document associated with the bookmark and the bookmark identifier; and
transmitting, from the server to the second touchpoint device, the electronic document at the bookmarked location.

11. The computer-implemented method according to claim 10, wherein the first touchpoint device is the same as the second touchpoint device.

12. The computer-implemented method according to claim 10, wherein the first touchpoint device or the second touchpoint device is selected from a mobile phone, automated teller machine, kiosk, or personal data assistant.

13. The computer-implemented method according to claim 10, wherein the first touchpoint device or the second touchpoint device is selected from a personal computer or a tablet computer.

14. The computer-implemented method according to claim 10, wherein the bookmark identifier comprises a symbol, letter, number, character, icon, picture, bar code, or QR code.

15. The computer-implemented method according to claim 10, wherein creating the bookmark identifier comprises the server automatically generating a bookmark identifier for the electronic document.

16. The computer-implemented method according to claim 10, further comprising receiving a selection by the user of a bookmark identifier for the electronic document.

17. The computer-implemented method according to claim 10, further comprising:
receiving input from the user in a field in the electronic document on the first touchpoint device;
storing the input in the database; and
providing the electronic document to the user on the second touchpoint device with the input received from the user.

18. The computer-implemented method according to claim 10, further comprising:
associating the bookmark at a designated point in the electronic document; and
when the user approaches the designated point in the electronic document, requesting the user to continue reviewing the electronic document at the second touchpoint device.
